(19) United States
(12) Patent Application Publication
(10) Pub. No.: US 2010/0049645 A1
(43) Pub. Date: Feb. 25, 2010

(54) Exhibiting Method of Exhibition

(76) Inventors: Yaai HU, Shenzhen (CN); Jiazheng PENG, Shenzhen (CN); Yiping PENG, Shenzhen (CN)

Correspondence Address: TROXELL LAW OFFICE PLLC, 4338 OLD COLUMBIA PIKE, ANNANDALE, VA, 22003, US

(21) Appl. No.: 12/541,923

(22) Filed: Aug. 15, 2009

(30) Foreign Application Priority Data
Aug. 20, 2008 (CN) 200810141916.3

(51) Int. Cl. G06Q 40/00; H04N 5/225

(52) U.S. Cl. 705/35; 348/207.99

(57) ABSTRACT

The present invention involves an exhibiting method of exhibition. The present invention comprises the following steps: first, mount a display terminal in an exhibition building and/or at an exhibiting booth, and mount an image pickup device at the position where the content to be exhibited is located; second, send the video shot by the image pickup device about the content to be exhibited via network to the display terminal mounted in the exhibition building and/or at the exhibiting booth, and visitors view the content to be exhibited via the display terminal. An exhibitor can at anywhere send the content to be exhibited via network video to the exhibition building and/or the exhibiting booth for the visitors to view, so, the high cost of traveling, accommodation, etc. is saved, and, the time for transporting the exhibits and the traveling time of the exhibitors are completely saved. The technical problem of the existing exhibiting method of exhibition that the exhibitors need to spend a lot of time and cost is saved.

### BACKGROUND OF THE INVENTION

1. Field of the Invention

The present invention involves an exhibiting method of exhibition.

2. Description of the Related Art

In all the existing exhibiting methods of exhibition, the exhibitors themselves need to arrange exhibits in the exhibition building at various kinds of locales; to get the content exhibited at every exhibiting booth in the exhibition building visitors need to visit the exhibiting booths on the spot. In this kind of exhibitions, exhibitors not only need to spend the high cost of traveling, accommodation, arranging exhibits, etc. within the time and locale restriction of the exhibition, but also need to spend a lot of traveling time, which are inconvenient for the exhibitors.

### SUMMARY OF THE INVENTION

The present invention provides an exhibiting method of exhibition, solving the technical problems that the existing exhibiting methods of exhibition need to take the exhibitors a lot of time and cost while the exhibitors attend an exhibition.

To solve the above mentioned technical problems, the present invention provides the following technical solution.

An exhibiting method of exhibition comprises the following steps:

first, mount a display terminal in an exhibition building and/or at an exhibiting booth, and mount an image pickup device at the position where the content to be exhibited is located;

second, send the video shot by the image pickup device about the content to be exhibited via network to the display terminal mounted in the exhibition building and/or at the exhibiting booth, and visitors view the content to be exhibited via the display terminal.

The exhibition building and/or the exhibiting booth and the position where the content to be exhibited is located are separately provided with a two-way communication device for the visitors and the exhibitors to do a two-way communication.

The two-way communication device comprises an audio transceiver and/or a computer.

A network exhibition platform is provided on the network, and the exhibition organizer can control and manage the visitors and the exhibitors via the network exhibition platform.

The control and management comprise register management, payment management, interacting management, storage management of audio and video, and data statistics management.

The image pickup device is a video camera or a camera terminal.

After adopting the above mentioned technical solution, an exhibitor can at anywhere send the content to be exhibited via network video to the exhibition building and/or the exhibiting booth for the visitors to view, so, the high cost of traveling, accommodation, etc. is saved, and, the time for transporting the exhibits and the traveling time of the exhibitors are completely saved. The technical problem of the existing exhibiting method of exhibition that the exhibitors need to spend a lot of time and cost is saved. Besides, if only a display terminal is mounted to the exhibition building and/or the exhibiting booth, the exhibition can be carried out, so, the exhibition capacity of the exhibition building is greatly increased, and the exhibitors and the visitors are increased.

### DESCRIPTION OF THE PREFERRED EMBODIMENT

The exhibiting method of exhibition of the present invention comprises the following steps:

First, mount a display terminal in an exhibition building and/or at an exhibiting booth, and mount an image pickup device, such as a video camera or a camera, at the position where the content to be exhibited is located; second, send the video shot by the image pickup device about the content to be exhibited via network to the display terminal mounted in the exhibition building and/or at the exhibiting booth, and visitors view the content to be exhibited via the display terminal. A network exhibition platform is provided on the network, and the exhibition organizer can control and manage the visitors and the exhibitors via the network exhibition platform. The exhibition building and/or the exhibiting booth, and the position where the content to be exhibited is located are separately provided with a two-way communication device for the visitors and the exhibitors to do a two-way communication. The two-way communication device comprises an audio transceiver and/or a computer; the visitors and the exhibitors do a two-way communication via the audio transceiver and/or the computer. The control and management comprise register management, payment management, interacting management, storage management of audio and video, and data statistics management. For example, an exhibitor needs to register and/or pay to get a password before entering the network exhibition platform, and the exhibitor can only enter the network exhibition platform after verifying the password; the audio and video can be stored according to the requirements; the visitors and the exhibitors are permitted or limited to do Interactive communication; and the statistical data about the visitors, the exhibitors, etc. can be managed. An exhibitor can at anywhere send the content to be exhibited via network video to the exhibition building and/or the exhibiting booth for the visitors to view, so, the high cost of traveling, accommodation, etc. is saved, and, the time for transporting the exhibits and the traveling time of the exhibitors are completely saved. The technical problem of the existing exhibiting method of exhibition that the exhibitors need to spend a lot of time and cost is saved. Besides, if only a display terminal is mounted to the exhibition building and/or the exhibiting booth, the exhibition can be carried out, so, the exhibition capacity of the exhibition building is greatly increased, and the quantity of the exhibitors and the visitors is increased.

What is claimed is:

1. An exhibiting method of exhibition comprising the following steps: mounting a display terminal in an exhibition building and/or at an exhibiting booth, and mounting an image pickup device at the position where the content to be exhibited is located; sending the video shot by the image pickup device about the content to be exhibited via network to the display terminal mounted in the exhibition building and/or at the exhibiting booth, and visitors viewing the content to be exhibited via the display terminal.

2. The exhibiting method of exhibition of claim 1, wherein the image pickup device is a video camera or a camera terminal.

3. The exhibiting method of exhibition of claim 1, wherein the exhibition building and/or the exhibiting booth, and the position where the content to be exhibited is located are separately provided with a two-way communication device for the visitors and the exhibitors to do a two-way communication.

4. The exhibiting method of exhibition of claim 3, wherein the two-way communication device comprises an audio transceiver and/or a computer.

5. The exhibiting method of exhibition of claim 3, wherein a network exhibition platform is provided on the network, and the exhibition organizer can control and manage the visitors and the exhibitors via the network exhibition platform.

6. The exhibiting method of exhibition of claim 3, wherein the control and management comprise register management, payment management, interacting management, storage management of audio and video, and data statistics management.

7. The exhibiting method of exhibition of claim 3, wherein the display terminal is a wireless display terminal or a hand-held display terminal.

8. The exhibiting method of exhibition of claim 3, wherein the image pickup device is a video camera or a camera terminal.
